(19) United States
(12) Patent Application Publication
(10) Pub. No.: US 2011/0157114 A1
(43) Pub. Date: Jun. 30, 2011

(54) ELECTROLUMINESCENCE DEVICE

(75) Inventors: Kai-Yuan Ko, Taichung City (TW); Yuan-Chun Wu, Taoyuan County (TW); Lee-Hsun Chang, Hsinchu County (TW)

(73) Assignee: AU OPTRONICS CORPORATION, Hsinchu (TW)

(21) Appl. No.: 12/761,385

(22) Filed: Apr. 15, 2010

(30) Foreign Application Priority Data
Dec. 31, 2009 (TW) 98146353

(51) Int. Cl. G06F 3/038

(52) U.S. Cl. 345/206; 345/77

(57) ABSTRACT

An electroluminescence device includes a substrate, a pixel array, lead line sets, driving devices and at least one power transmission pattern. The substrate has a display region and a peripheral circuit region. The pixel array is disposed in the display region and includes pixel structures. Each pixel structure has at least one active element and a light emitting element. The lead line sets are disposed in the peripheral circuit region and electrically connected to the pixel array, and each lead line set has multiple lead lines. Each driving device is electrically connected to one lead line set. The power transmission pattern is disposed in the peripheral circuit region and between adjacent lead line sets. One end of the power transmission pattern is electrically connected to the light emitting element and another end of the power transmission pattern is electrically connected to one corresponding driving device.

### CROSS-REFERENCE TO RELATED APPLICATION

This application claims the priority benefit of Taiwan application serial no. 98146353, filed on Dec. 31, 2009. The entirety of the above-mentioned patent application is hereby incorporated by reference herein and made a part of specification.

### BACKGROUND OF THE INVENTION

1. Field of the Invention

The present invention relates to a light emitting device, and more particularly, to an electroluminescence device.

2. Description of Related Art

As an emissive device, the electroluminescence device has the advantages of no view angle limit, low fabrication cost, high response speed (about more than one hundred times faster than the response speed of the liquid crystal), power saving, adaptability to direct current driving in portable devices, broad operating temperature range, light weight, as well as providing miniature and low-profile design Therefore, the electroluminescence device has a great development potential and is expected to be the next generation of flat panel display.

One typical electroluminescence device includes a top electrode layer, a bottom electrode layer, and a light emitting layer sandwiched between the two electrode layers. The bottom electrode layer is usually made of a transparent conductive material for transmission of lights emitted by the light emitting layer. However, as the electroluminescence device becomes larger and larger in size, a voltage drop occurred due to the resistance of the power lines may cause a clear difference between the voltage of the pixels adjacent the power input end and the voltage of the pixels far away from the power input end. Because luminance of each pixel of the electroluminescence device depends on the current flowing through that pixel, the clear voltage difference would result in the poor overall light emitting uniformity of the electroluminescence device.

### SUMMARY OF THE INVENTION

Accordingly, the present invention is directed to an electroluminescence device which can improve the overall light emitting uniformity of the electroluminescence device.

The present invention provides an electroluminescence device including a substrate, a pixel array, a plurality of lead line sets, a plurality of driving devices, and at least one power transmission pattern. The substrate includes a display region and a peripheral circuit region around the display region. The pixel array is disposed in the display region and has a plurality of pixel structures. Each of the pixel structures includes at least one active element and a light emitting element electrically connected to the at least one active element. The lead line sets are disposed in the peripheral circuit region of the substrate and electrically connected with the pixel array. Each of the lead line sets has a plurality of lead lines. Each driving device is electrically connected with one corresponding lead line set. The power transmission pattern is disposed in the peripheral circuit region of the substrate and between the adjacent lead line sets. One end of the power transmission pattern is electrically connected to the light emitting element of the pixel array, and another end of the power transmission pattern is electrically connected to one corresponding driving device.

The present invention provides an electroluminescence device including a substrate, a pixel array, a plurality of lead line sets, at least one driving devices, and at least one power transmission pattern. The pixel array is disposed in the display region of the substrate and has a plurality of pixel structures. Each pixel structure includes at least one active element and a light emitting element electrically connected to the at least one active element. The lead line sets are disposed on the substrate and electrically connected with the pixel array. Each of the lead line set has a plurality of lead lines. The driving device is electrically connected one of the lead line sets. The power transmission pattern is disposed between the adjacent lead line sets, with one end of the power transmission pattern being electrically connected with the light emitting element of the pixel array and another end of the power transmission pattern being electrically connected to one corresponding driving device.

In view of the foregoing, the power transmission pattern is disposed between the adjacent lead line sets, with one end of the power transmission pattern being electrically connected to the light emitting element of the pixel array and another end of the power transmission pattern being electrically connected with one corresponding driving device. The provision of the power transmission pattern can reduce the voltage drop on the power lines, thereby improving the overall light emitting uniformity of the electroluminescence device.

In order to make the aforementioned and other features and advantages of the present invention more comprehensible, embodiments accompanied with figures are described in detail below.

### BRIEF DESCRIPTION OF THE DRAWINGS

FIG. 1 is a top view of an electroluminescence device according to one embodiment of the present invention.

FIG. 2 illustrates an equivalent circuit of the pixel array of the electroluminescence device of FIG. 1.

FIG. 3 is a partial view of the peripheral circuit region of FIG. 1.

FIG. 4 is a cross-sectional view of one pixel structure of the pixel array of FIG. 2.

FIG. 5 is a cross-sectional view of FIG. 1, taken along A-A′ thereof.

FIG. 6 is a partial view of a peripheral circuit region of an electroluminescence device according to another embodiment of the present invention.

### DESCRIPTION OF THE EMBODIMENTS

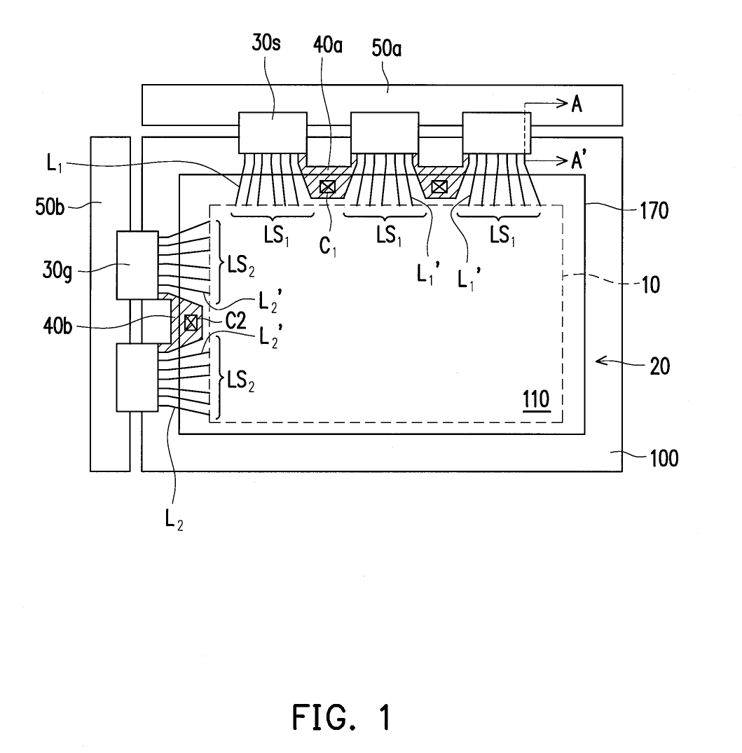

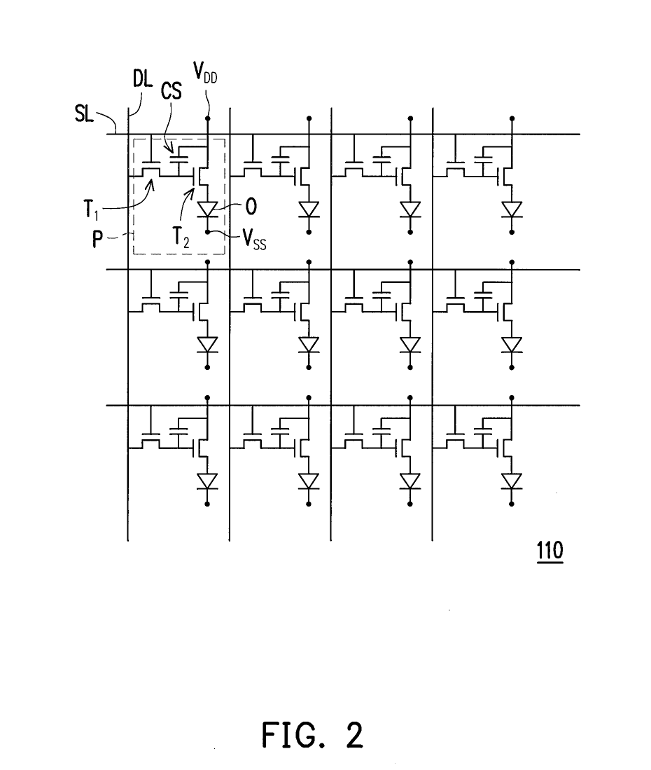

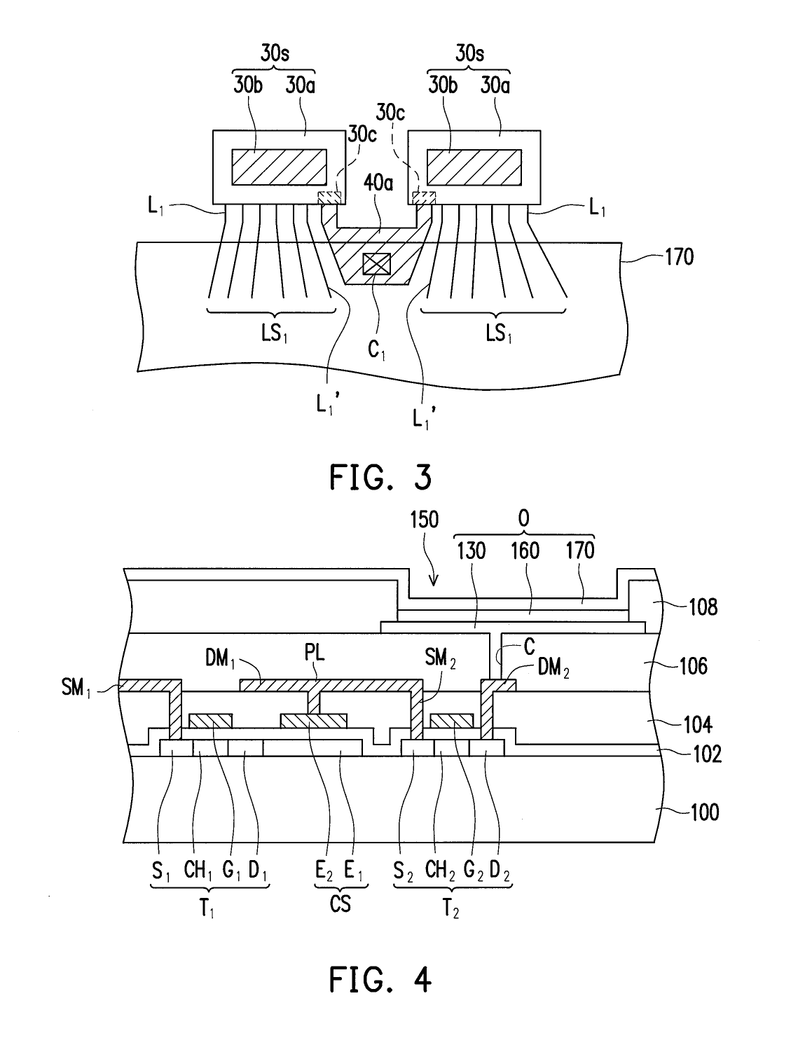

FIG. 1 is a top view of an electroluminescence device according to one embodiment of the present invention. FIG. 2 illustrates an equivalent circuit of the pixel array of the electroluminescence device of FIG. 1. FIG. 3 is a partial view of the peripheral circuit region of FIG. 1. FIG. 4 is a cross-sectional view of one pixel structure of the pixel array of FIG. 2.

Referring first to FIG. 1, the electroluminescence device of the present embodiment includes a substrate 100, a pixel array 110, a plurality of lead line sets LS, a plurality of driving devices 30s, 30g, and at least one power transmission pattern 40a, 40b.

The substrate 100 includes a display region 10 and a peripheral circuit region 20 around the display region 10. The substrate 100 may be a transparent substrate such as a transparent glass substrate or a transparent flexible substrate. The substrate 100 is mainly used to support components of the electroluminescence device. In order to enable the light emitted by the electroluminescence device to penetrate through the substrate 100, the substrate 100 is made of a transparent or light transmitting material. Electroluminescence devices that emit light from the substrate 100 are also generally referred to as bottom-emitting electroluminescence devices.

Referring to FIG. 1 and FIG. 2, the pixel array 110 is disposed in/on the display region 10. The pixel array 110 includes a plurality of pixel structures P. Each pixel structure P includes at least one active element T₁, T₂, and at least one light emitting element O electrically connected to the active element T₁, T₂. In one embodiment of the present invention, the pixel array 110 further includes a plurality of scan lines SL, a plurality of data lines DL, and a plurality of power lines PL (see FIG. 4) connected to a voltage source V_{DD}. Each pixel structure P is connected with one corresponding scan line SL, one corresponding data line DL, and one corresponding power line PL (see FIG. 4). In the present embodiment, each pixel structure P includes a first active element T₁, a second active element T₂, and a capacitor CS. The light emitting element O includes a first electrode layer 130, a light emitting layer 160, and a second electrode layer 170. In the present embodiment, each pixel structure P is illustrated as having two active elements and one capacitor (2T1C), it is noted that this is for the purposes of illustration only and therefore should not be regarded as limiting. Rather, the present invention is not intended to limit the number of the active element and capacitor of each pixel structure P.

In the present embodiment, referring to FIG. 2 and FIG. 4, in the 2T1C pixel structure, the active element T₁ has a gate G₁, a source S₁, a drain D₁, and a channel CH₁. The source S₁ is electrically connected with the data line DL₁, the gate G₁ is electrically connected with the scan line SL, and the drain D₁ is electrically connected with the active element T₂. The active element T₂ has a gate G₂, a source S₂, a drain D₂, and a channel CH₂. The gate G₂ of the active element T₂ is electrically connected with the drain D₁ of the active element T₁. The source S₂ of the active element T₂ is electrically connected with the power line PL₁. One electrode end E₁ of the capacitor CS is electrically connected with the drain D₁ of the active element T₁, and the other electrode end E₂ of the capacitor CS is electrically connected with the source S₂ of the active element T₂ and the power line PL₁. The above active elements T₁, T₂ are illustrated as top-gate thin-film transistors (also referred to as poly-silicon thin-film transistors). In other words, the source S₁, drain D₁ and channel CH₁ of the active element T₁ are formed within a semiconductor layer (poly-silicon layer). A gate insulating layer 102 is formed between this semiconductor layer and the gate G₁, and another insulating layer 104 is formed over the gate G₁. The source S₁ is electrically connected to the power line DL₁ via a source metal layer SM₁ that extends through the insulating layers 104, 106. The drain D1 is electrically connected to the source S₂ of the active element T₂ via a drain metal layer DM₁ that extends through the insulating layers 104, 106. Besides, the source S₂, drain D₂ and channel CH₂ of the active element T₂ are formed within a semiconductor layer (poly-silicon layer). Similarly, the gate insulating layer 102 is formed between this semiconductor layer and the gate G₂, and another insulating layer 104 is formed over the gate G₂. The source S₂ is electrically connected to the power line DL₁ via a source metal layer SM₂ that extends through the insulating layers 104, 106. The drain D₂ is electrically connected to a drain metal layer DM₂ that extends through the insulating layers 104, 106.

In the present embodiment, the active elements T₁, T₂ are illustrated as top-gate thin-film transistors (also referred to as poly-silicon thin-film transistors). However, this is for the purposes of illustration only and therefore should not be regarded as limiting. In other embodiments, the active elements T₁, T₂ may also be bottom-gate thin-film transistors (also referred to as amorphous silicon thin-film transistor). In addition, the pixel structures P shown in FIG. 2 and FIG. 4 are for the purposes of illustration only and should not be regarded as limiting. Rather, in other embodiments, the pixel structures P may be configured and arranged in a different manner.

As shown in FIG. 2 and FIG. 4, another insulating layer 106 is formed over the first active element T₁, the second active element T₂, and the capacitor CS. The light emitting device O is disposed on the insulating layer 106. The light emitting device O includes the first electrode layer 130, the light emitting layer 160, and the second electrode layer 170.

The first electrode layer 130 is disposed on the surface of the insulating layer 106 and is electrically connected with the drain D₂ of the active element T₂. In the present embodiment, the first electrode layer 130 is electrically connected to the drain metal layer DM₂ of the active element T₂ via a contact window C formed in the insulating layer 106. The first electrode layer 130 is a transparent electrode layer that may be made of metal oxide such as indium tin oxide or indium zinc oxide. Besides, another insulating layer 108 is formed over the first electrode layer 130. The insulating layer 108 has an opening 150 that exposes the first electrode layer 130. In each pixel region 110, the area occupied by the opening 150 is substantially equal to or slightly less than the area occupied by the first electrode layer 130.

The light emitting layer 160 is disposed on the first electrode layer 130 exposed from the opening 150. The light emitting layer 160 may be an organic light emitting layer or inorganic light emitting layer. The electroluminescence device may be referred as an organic electroluminescence device or an inorganic electroluminescence device depending upon the material of the light emitting layer 160. Besides, the light emitting layer 160 of the light emitting element O of each pixel structure P has a red organic light emitting pattern, green organic light emitting pattern, blue organic light emitting pattern, or multi-layered (e.g. white, orange, and/or purple) light emitting pattern formed by mixing a desired spectrum of lights.

The second electrode layers 170 may be formed by an unpatterned electrode layer over the light emitting layer 160 and extends to the surface of the insulating layer 108. In the present embodiment, the second electrode layers 170 of the light emitting elements O of all pixel structures P are electrically connected with one another because they form a single layer (unpatterned electrode layer). The second electrode layer 170 may be a metal electrode layer or a transparent conductive layer. Besides, the multiple insulating layers 108, 106 are formed between the second electrode layer 170 and the active elements T₁, T₂ on the substrate 100. Therefore, at least two insulating layers 108, 106 are interposed between the second electrode layer 170 and the active elements T₁, T₂, scan line SL, data line DL, power line PL and lead line sets LS₁, LS₂.

In another embodiment, the light emitting element O may further include an electron injection layer, a hole injection layer, an electron transmission layer, and a hole transmission layer.

As shown in FIG. 1, the lead line sets LS₁, LS₂ are disposed in the peripheral circuit region 20 of the substrate 100 and electrically connected with the pixel array 110. Each lead line set LS₁ has a plurality of lead lines L₁ and each lead line set LS₂ has a plurality of lead lines L₂. In the present embodiment, the lead line set LS₁ is electrically connected with the data lines DL of the pixel array 110 and the lead line set LS₂ is electrically connected with the scan lines SL of the pixel array 110. However, this is for the purposes of illustration only and should not be regarded as limiting. The lead line set LS₁ may also be configured to be electrically connected with the data lines DL and part of the scan lines SL of the pixel array 110 to reduce the number of lead lines that would be required in the original design of the lead line set LS₂. In an alternative embodiment, the lead line set LS₂ may also be configured to be electrically connected with part of the data lines DL and the scan lines SL of the pixel array 110 to reduce the number of lead lines that would be required in the original design of the lead line set LS₁. In another alternative embodiment, the lead line set LS₁ may be configured to be electrically connected with all the data lines DL and scan lines SL of the pixel array 110 to significantly reduce the number of lead lines that would be required in the original design of the lead line set LS₂. In still another alternative embodiment, the lead line set LS₂ may be configured to be electrically connected with all the data lines DL and scan lines SL of the pixel array 110 to significantly reduce the number of the lead lines that would be required in the original design of the lead line set LS₁. More specifically, the lead lines L₁ of the lead line set LS₁ are electrically connected with the data lines DL, respectively. The lead lines L₂ of the lead line set LS₂ are electrically connected with the scan lines SL of the pixel array 110, respectively. In addition, the power line PL (electrically connected with voltage source V_{DD}) of the pixel array 110 may be electrically connected with other lead lines L₁′ (those not electrically connected with the data lines DL) of the lead line set LS₁ or other lead lines L₂′ (those not electrically connected with the san lines SL) of the lead line set LS₂.

The driving devices 30s, 30g are electrically connected with the lead line sets LS₁, LS₂, respectively. In the present embodiment, the driving device 30s is also referred to as a source driving device and the driving device 30g is also referred to as a gate driving device. The source driving devices 30s are electrically connected with the data lines DL via the lead line set LS₁. The gate driving devices 30g are electrically connected with the scan lines SL via the lead line set LS₂. In one embodiment of the present invention, as shown in FIG. 3, each driving device 30s includes a flexible circuit board 30a and a chip 30b disposed on the flexible circuit board 30a. Therefore, the driving device 30s may be referred to as a chip on film (COF). Similarly, each driving device 30g also includes a flexible circuit board and a chip disposed on the flexible circuit board (not shown).

Referring to FIG. 1 and FIG. 3, the power transmission pattern 40a is disposed in the peripheral circuit region 20 of the substrate 100 and between two of the adjacent lead line sets LS₁. As such, the using rate of the area is improved. In particular, one end of each power transmission pattern 40a is electrically connected with the second electrode layer 170 of the light emitting element O of the pixel array 110, and another end of each power transmission pattern 40a is electrically connected with one corresponding driving device 30s. Similarly, the power transmission pattern 40b is disposed in the peripheral circuit region 20 of the substrate 100 and between two of the adjacent lead line sets LS₂. One end of each power transmission pattern 40b is electrically connected with the second electrode layer 170 of the light emitting element O of the pixel array 110, and another end of each power transmission pattern 40b is electrically connected with one corresponding driving device 30g.

In the present embodiment, the power transmission pattern 40a is electrically connected with two adjacent driving devices 30s. In other words, because the power transmission pattern 40a is disposed between two adjacent lead line sets LS₁, the power transmission pattern 40a can be electrically connected with the driving devices 30s that are electrically connected with the adjacent lead line sets LS₁. Similarly, the power transmission pattern 40b is electrically connected with two adjacent driving devices 30g. In other words, because the power transmission pattern 40b is disposed between two adjacent lead line sets LS₂, the power transmission pattern 40b can be electrically connected with the driving devices 30g that are electrically connected with the adjacent lead line sets LS₂. More specifically, in the present embodiment, as shown in FIG. 3, the flexible circuit board 30a of the driving device 30s usually includes at least one dummy pad 30c thereon. The power transmission pattern 40a is electrically connected with the driving device 30s by being electrically connected to the dummy pad 30c. Similarly, the flexible circuit board of the driving device 30g usually includes at least one dummy pad (not shown) thereon. The power transmission pattern 40b is electrically connected with the driving device 30g by being electrically connected to the dummy pad. In addition, each power transmission pattern 40a is electrically connected with the second electrode layer 170 of the light emitting element O of the pixel array 110 via a contact window C₁. Each power transmission pattern 40b is electrically connected with the second electrode layer 170 of the light emitting element O of the pixel array 110 via a contact window C₂.

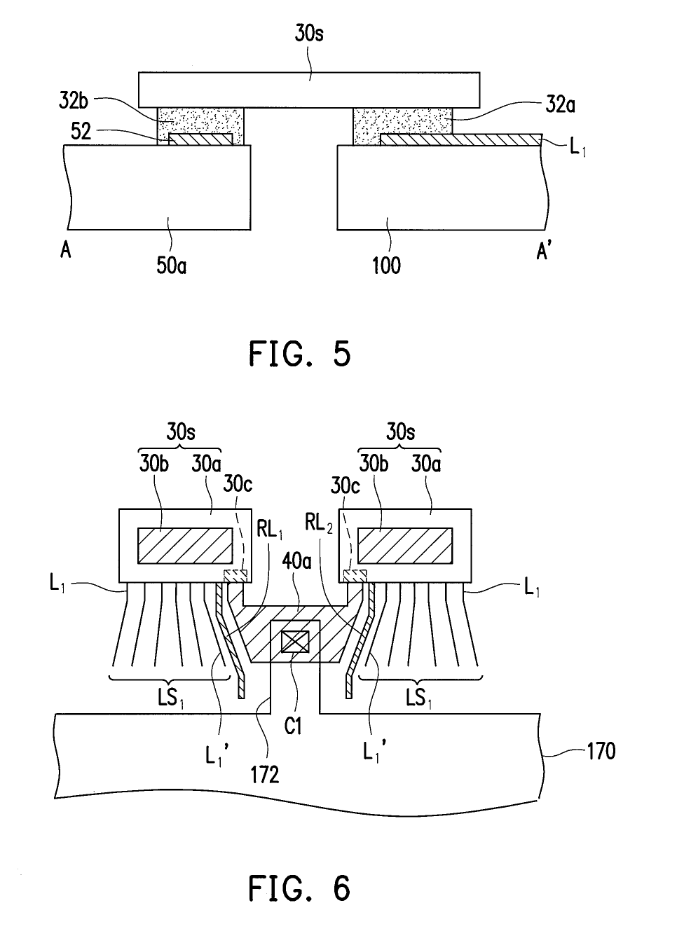

Besides, the driving devices 30s, 30g may be electrically connected with the lead line sets LS₁, LS₂ via an anisotropic conductive adhesive. Taking the driving device 30s and the lead line set LS₁ as an example, as shown in FIG. 5, the anisotropic conductive adhesive 32a may be applied between the lead line set LS₁ (lead line L₁) on the substrate 100 and the driving device 30s to electrically connect the lead line set LS₁ (lead line L1) to the driving device 30s.

In addition, as shown in FIG. 1, the electroluminescence device of the present embodiment further includes circuit boards 50a, 50b. The circuit board 50a is electrically connected with the driving device 30s, and the circuit board 50b is electrically connected with the driving device 30g. More specifically, the driving devices 30s, 30g can be electrically connected to the circuit board 50a, 50b via an anisotropic conductive adhesive. Taking the driving device 30s and circuit board 50a as an example, as shown in FIG. 5, the anisotropic conductive adhesive 32b may be applied between a pad 52 on the circuit board 50a and the driving device 30s to electrically connect the circuit board 50a to the driving device 30s.

Furthermore, in one embodiment of the present invention, the power transmission patterns 40a, 40b are electrically connected to a ground potential. Therefore, the power transmission patterns 40a, 40b are used to transmit a ground potential. In other words, after the ground potential is transmitted to the power transmission patterns 40a, 40b through the circuit boards 50a, 50b and the driving devices 30a, 30g, the ground potential is further transmitted to the second electrode layer 170 of the light emitting element O of the pixel array 110. This causes the voltage source Vss to which the second electrode layer 170 of the light emitting diode O is electrically connected to be the ground potential, and the lead line L₁′ (or lead line L₂′) transmits the potential of the voltage source V_{DD}.

In another embodiment of the present invention, the power transmission patterns 40a, 40b are electrically connected to a driving voltage ranging from about −10 V to 0 V. Therefore, the power transmission patterns 40a, 40b are used to transmit a driving voltage. In other words, after the driving voltage is transmitted to the power transmission patterns 40a, 40b through the circuit boards 50a, 50b and the driving devices 30s, 30g, the driving voltage is further transmitted to second electrode layer 170 of the light emitting element O of the pixel array 110. This causes the potential of the voltage source V_{DD} to which the second electrode layer 170 of the light emitting diode O is electrically connected to be the driving voltage and, in this case, the lead line L₁′ (or lead line L₂′) transmits the ground potential of the voltage source Vss.

FIG. 6 is a partial view of a peripheral circuit region of an electroluminescence device according to another embodiment of the present invention. Referring to FIG. 6, the embodiment of FIG. 6 is similar to the embodiment of FIG. 3, where like elements are referenced by like numerals and therefore explanation thereof is not repeated herein. The difference between the embodiments of FIG. 6 and FIG. 3 lies in that the electroluminescence device of the embodiment of FIG. 6 further includes at least one repair line RL₁, RL₂ disposed between the power transmission pattern 40a and the lead line set LS₁. In general, the repair line RL₁, RL₂ of the electroluminescence device may be reserved to repair defective pixels in the pixel array 110 to increase the yield of the electroluminescence device. The repair line RL₁, RL₂ is usually electrically connected with the driving device 30s. However, if the electroluminescence device is provided with the repair line RL₁, RL₂, the repair line RL₁, RL₂ does not overlap with the second electrode layer 170 of the light emitting element O. This is mainly because that abnormal short circuit or electrical connection can be prevented from occurring between the repair line RL₁, RL₂ and the second electrode layer 170 of the light emitting element O during the repairing process of the repair line RL₁, RL₂ by arranging the repair line RL₁, RL₂ and the second electrode layer 170 of the light emitting element O not to overlap with each other.

In order to electrically connect the second electrode layer 170 to the power transmission pattern 40a, the electroluminescence device of the embodiment of FIG. 6 further includes a connecting portion 172 disposed between the second electrode layer 170 and the power transmission pattern 40a to electrically connect the second electrode layer 170 to the power transmission pattern 40a. In this embodiment, the connecting portion 172 is electrically connected with the power transmission pattern 40a via the contact window C₁, and the connecting portion 172 is directed connected with the second electrode layer 170. In other words, because the connecting portion 172 and the power transmission pattern 40a are formed in different layers with the insulating layers interposed therebetween, the connecting portion 172 and the power transmission pattern 40a are electrically connected via the contact window C₁. In addition, because the connecting portion 172 and the second electrode layer 170 are formed in the same layer, the connecting portion 172 can be directly connected with the second electrode layer 170.

While the repair line RL₁, RL₂ is illustrated as being only disposed between the power transmission pattern 40a and the lead line set LS₁ in the embodiment of FIG. 6, at least one repair line (not shown) may also be disposed between the power transmission pattern 40b and the lead line set LS₂ in alternative embodiments. The repair line between the power transmission pattern 40b and the lead line set LS₂ may be constructed in the same way as described above with respect to the repair line RL₁, RL₂, the design and arrangement of the repair line between the power transmission pattern 40b and the lead line set LS₂ can therefore be appreciated by those skilled in the art upon reading the above description with reference to FIG. 6.

In the embodiments described above, it is illustrated that the driving circuits 30s, 30g, lead line sets LS₁, LS₂, power transmission pattern 40a, 40b, and circuit board 50a, 50b are disposed in the peripheral circuit region 20 at two sides of the display region 10. However, this is for the purposes of illustration only and should not be regarded as limiting. In alternative embodiments, the driving circuits, lead line sets, power transmission patterns, and circuit boards may also be disposed in the peripheral circuit region 20 at one side of the display region 10. Besides, the present invention is not intended to limit the number of the driving circuits, 30s, 30g, lead line sets LS₁, LS₂, and power transmission patterns 40a, 40b. Rather, the number of the driving circuits 30s, 30g, lead line sets LS₁, LS₂, and power transmission patterns 40a, 40b may vary depending upon the size of the electroluminescence device. Moreover, it is not intended to require one power transmission pattern be disposed between every two adjacent lead line sets. One or more power transmission pattern(s) may be disposed between the adjacent lead line sets based on actual requirements of the electroluminescence device.

In summary, the power transmission power is disposed between two adjacent lead line sets, with one end of the power transmission pattern being electrically connected to the light emitting element of the pixel array and another end of the power transmission pattern being electrically connected with one corresponding driving device. Therefore, the provision of the power transmission pattern can reduce the voltage drop on the power line, thereby improving the overall light emitting uniformity of the electroluminescence device.

In addition, the power transmission pattern is disposed in the spare space between the existing lead line sets, and therefore, extra space is not required for the power transmission pattern.

Moreover, electrical connection with the power transmission pattern is achieved through the dummy pad on the flexible circuit board of existing driving circuit. Therefore, an extra flexible circuit board is not required for electrical connection with the power transmission pattern.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electroluminescence device comprising:
a substrate, having a display region and a peripheral circuit region around the display region;
a pixel array, disposed in the display region and having a plurality of pixel structures, each of the pixel structures comprising at least one active element and a light emitting element electrically connected to the at least one active element;
a plurality of lead line sets, disposed in the peripheral circuit region of the substrate and electrically connected with the pixel array, each of the lead line sets having a plurality of lead lines;
a plurality of driving devices, each electrically connected with one corresponding lead line set; and
at least one power transmission pattern, disposed in the peripheral circuit region of the substrate and between the adjacent lead line sets, one end of the power transmission pattern being electrically connected to the light emitting element of the pixel array, another end of the power transmission pattern being electrically connected to one corresponding driving device.

2. The electroluminescence device according to claim 1, wherein the power transmission pattern is electrically connected with two of the adjacent driving devices.

3. The electroluminescence device according to claim 1, wherein each of the driving devices comprises a flexible circuit board and a chip on the flexible circuit board.

4. The electroluminescence device according to claim 3, wherein the flexible circuit board comprises at least one dummy pad thereon, and the power transmission pattern is electrically connected with the dummy pad.

5. The electroluminescence device according to claim 1, wherein the power transmission pattern is electrically connected with the light emitting element via a contact window.

6. The electroluminescence device according to claim 1, further comprising at least one repair line disposed between the power transmission pattern and one corresponding lead line set, wherein the light emitting element comprises a first electrode layer, a light emitting layer disposed on the first electrode layer, and a second electrode layer disposed on the light emitting layer, and the repair line and the second electrode layer do not overlap with each other.

7. The electroluminescence device according to claim 6, further comprising a connecting portion disposed between the second electrode layer and the power transmission pattern, wherein the connecting portion is electrically connected with the second electrode layer and the power transmission pattern.

8. The electroluminescence device according to claim 7, wherein the connecting portion and the power transmission pattern are electrically connected via a contact window, and the connecting portion is directly connected with the second electrode layer.

9. The electroluminescence device according to claim 1, further comprising an anisotropic conductive adhesive disposed between the driving devices and the lead line sets.

10. The electroluminescence device according to claim 1, further comprising a circuit board electrically connected with the driving devices.

11. The electroluminescence device according to claim 10, further comprises an anisotropic conductive adhesive disposed between the driving devices and the circuit board.

12. The electroluminescence device according to claim 1, wherein the light emitting element of the pixel structure comprises a first electrode layer, a light emitting layer disposed on the first electrode layer, and a second electrode layer disposed on the light emitting layer, and the first electrode layer is electrically connected with at least one active element.

13. The electroluminescence device according to claim 1, wherein the pixel array further comprises a plurality of scan lines, a plurality data lines, and a plurality of power lines.

14. The electroluminescence device according to claim 13, wherein the driving devices comprise at least one source driving device and at least one gate driving device, the source driving devices are electrically connected to the data lines via a part of the lead line sets, and the gate driving devices are electrically connected to the scan lines via the other part of the lead line sets.

15. The electroluminescence device according to claim 1, wherein the at least one power transmission pattern transmits a ground potential.

16. The electroluminescence device according to claim 1, wherein the at least one power transmission pattern transmits a driving voltage ranging from about −10 V to 0 V.

17. An electroluminescence device comprising:
a substrate;
a pixel array, disposed in the display region of the substrate and having a plurality of pixel structures, each pixel structure comprising at least one active element and a light emitting element electrically connected to the at least one active element;
a plurality of lead line sets, disposed on the substrate and electrically connected with the pixel array, each of the lead line set having a plurality of lead lines;
at least one driving device, electrically connected with one of the lead line sets; and
at least one power transmission pattern, disposed between the adjacent lead line sets, one end of the power transmission pattern being electrically connected with the light emitting element of the pixel array, another end of the power transmission pattern being electrically connected to one corresponding driving device.
